(19) United States
(12) Patent Application Publication
(10) Pub. No.: US 2025/0292681 A1
(43) Pub. Date: Sep. 18, 2025

(54) INFORMATION PROCESSING APPARATUS AND OPERATING METHOD OF INFORMATION PROCESSING APPARATUS

(71) Applicant: TOYOTA JIDOSHA KABUSHIKI KAISHA, Toyota-shi Aichi-ken (JP)

(72) Inventors: Ibuki SHIMADA, Miyoshi-shi Aichi-ken (JP); Kazuhiro UMEDA, Mitaka-shi Tokyo-to (JP); Katsuhiro WATANABE, Kawasaki-shi Kanagawa-ken (JP); Koji UEDA, Funabashi-shi Chiba-ken (JP)

(73) Assignee: TOYOTA JIDOSHA KABUSHIKI KAISHA, Toyota-shi Aichi-ken (JP)

(21) Appl. No.: 19/074,926

(22) Filed: Mar. 10, 2025

(30) Foreign Application Priority Data
Mar. 13, 2024 (JP) 2024-039430

(51) Int. Cl. G08G 1/0968; G08G 1/127

(52) U.S. Cl. CPC G08G 1/096833; G08G 1/127

(57) ABSTRACT

An information processing apparatus includes a communication interface, a memory configured to store information on an operation plan for each of a plurality of vehicles, the operation plan including an operation route a portion or whole of which is included in one or more areas, and a controller configured to communicate using the communication interface, transmit, to a terminal apparatus, information indicating operation plans for the plurality of vehicles and a first area for which a predetermined reason has occurred, and upon receiving, from the terminal apparatus, an instruction to cease operating in the first area, transmit an instruction to cease operating to a first vehicle a portion or whole of an operation route for which is included in the first area.

### CROSS-REFERENCE TO RELATED APPLICATION

This application claims priority to Japanese Patent Application No. 2024-039430, filed on Mar. 13, 2024, the entire contents of which are incorporated herein by reference.

### TECHNICAL FIELD

The present disclosure relates to an information processing apparatus and an operating method of an information processing apparatus.

### BACKGROUND

Buses and other vehicles start operating according to the pre-planned start time of the service. Various technologies have been proposed to support such operation management. For example, Patent Literature (PTL) 1 discloses a system in which an operation management center transmits a travel permission to an automated driving vehicle in order to properly put the automated driving vehicle on a travel route.

### CITATION LIST

### Patent Literature

PTL 1: JP 2021-009431 A

### SUMMARY

In vehicle operation management, various factors may prevent a vehicle from starting to operate as planned, and in such cases, there is room to improve the efficiency of operations for operation instructions by the operation manager.

In the following, an information processing apparatus or the like that can improve operational efficiency for operation management is disclosed.

An information processing apparatus in the present disclosure includes:
a communication interface;
a memory configured to store information on an operation plan for each of a plurality of vehicles, the operation plan including an operation route a portion or whole of which is included in one or more areas; and
a controller configured to:
   communicate using the communication interface;
   transmit, to a terminal apparatus, information indicating operation plans for the plurality of vehicles and a first area for which a predetermined reason has occurred; and
   upon receiving, from the terminal apparatus, an instruction to cease operating in the first area, transmit an instruction to cease operating to a first vehicle a portion or whole of an operation route for which is included in the first area.

An operating method of an information processing apparatus in the present disclosure includes transmitting to a terminal apparatus, by an information processing apparatus configured to store information on an operation plan for each of a plurality of vehicles, the operation plan including an operation route a portion or whole of which is included in one or more areas, information indicating operation plans for the plurality of vehicles and a first area for which a predetermined reason has occurred, and upon receiving, from the terminal apparatus, an instruction to cease operating in the first area, transmitting, by the information processing apparatus, an instruction to cease operating to a first vehicle a portion or whole of an operation route for which is included in the first area.

According to the information processing apparatus or the like in the present disclosure, operational efficiency for operation management can be improved.

### BRIEF DESCRIPTION OF THE DRAWINGS

In the accompanying drawings:

FIG. 1 is a diagram illustrating an example configuration of an operation management system;

FIG. 2 is a diagram illustrating an example of operation plan information;

FIG. 3 is a sequence diagram illustrating an example operations of the operation management system;

FIG. 4 is a diagram illustrating an example of an operation management instruction screen; and

FIG. 5 is a diagram illustrating an example of the operation management instruction screen.

### DETAILED DESCRIPTION

An embodiment will be described below.

### <Configuration of Operation Management System>

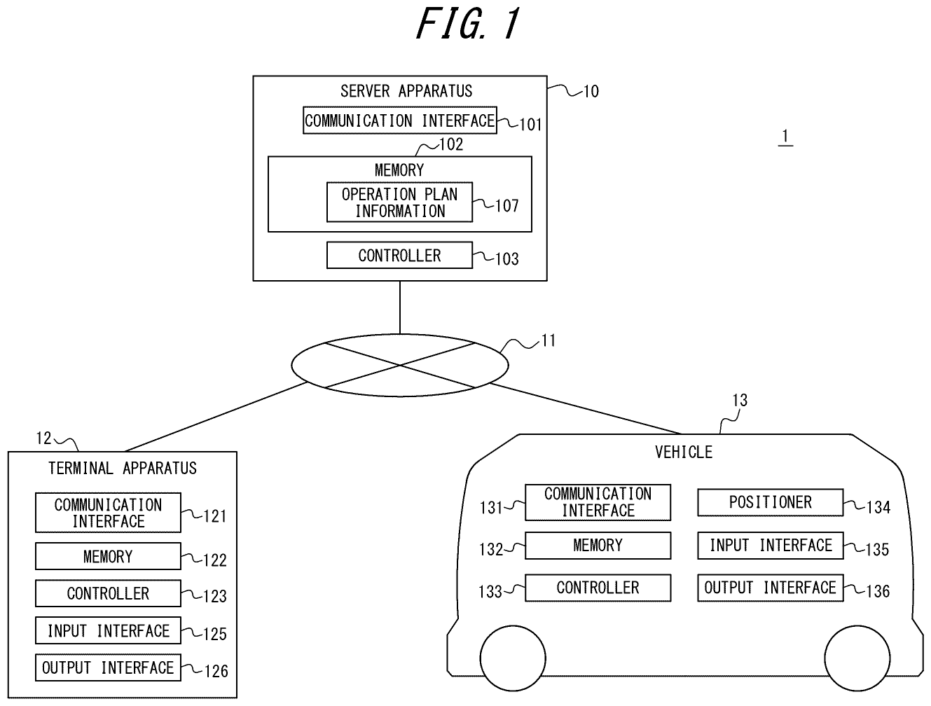

FIG. 1 is a diagram illustrating a configuration example of an operation management system 1 according to an embodiment. The operation management system 1 includes one or more server apparatuses 10, one or more terminal apparatuses 12, and a plurality of vehicles 13 communicably connected to each other via a network 11. The server apparatus 10 is, for example, a server computer that belongs to a cloud computing system or another computing system and functions as a server that implements various functions. The server apparatus 10 corresponds to “information processing apparatus” in the present embodiment. The terminal apparatus 12 is an information processing terminal used by the operator of the operation management system 1, i.e., the operation manager, and exchanges various information with the server apparatus 10. The terminal apparatus 12 is, for example, a personal computer, a tablet terminal apparatus, or the like. The vehicle 13 is provided with communication functions and information processing functions and is connected to the network 11 via a mobile communication network. The vehicle 13 is, for example, a bus vehicle that transports passengers and operates based on an operation plan. The vehicle 13 may be driven by a driver, or driving may be automated at any level, such as one of Level 1 to Level 5 defined by the Society of Automotive Engineers (SAE). The vehicle 13 is a battery electric vehicle (BEV) or a hybrid electric vehicle (HEV) that uses battery power for at least part of the energy for driving. The network 11 may, for example, be the Internet or may include an ad hoc network, a local area network (LAN), a metropolitan area network (MAN), other networks, or any combination thereof.

In the present embodiment, the operation management system 1 supports the operation management of the plurality of vehicles 13 by the operation manager. Operations management includes instructions to execute or cease the operation plan for each of the vehicles 13. Each of the vehicles 13 is assigned an operation plan that includes the operation route, start and end times, etc. Operational routes are established in any city block or district. The city block or district may also be divided into any one or more areas. Areas may be divided geographically or by function, attribute, or administrative division. The areas may overlap each other in part or more. A portion or whole of the operation route for each of the vehicles 13 is included in one or more areas.

The server apparatus 10 includes a communication interface 101, a memory 102, and a controller 103 that communicates using the communication interface 101. The memory 102 stores operation plan information, or operation plan information 107, including an operation route for each of the plurality of vehicles 13, a portion or whole of which is included in one or more areas. The controller 103 transmits, to the terminal apparatus 12, information indicating operation plans for the plurality of vehicles 13 and an area for which a predetermined reason (hereinafter referred to as “non-operable reason”) has occurred (hereinafter referred to as “non-operable area”), and upon receiving, from the terminal apparatus 12, an instruction to cease operating in the non-operable area, the controller 103 transmits an instruction to cease operating to a vehicle 13 a portion or whole of an operation route for which is included in the non-operable area. The operation manager can instruct the vehicles 13 that are scheduled to operate in a non-operable area to cease operating in the non-operable area on a non-operable area basis. Therefore, when multiple vehicles 13 are scheduled to operate in a non-operable area, the operation manager does not need to instruct each vehicle 13 to cease operating. Thus, it is possible to improve operational efficiency for operation management.

### <Configuration of Server Apparatus 10>

The server apparatus 10 includes the communication interface 101, the memory 102, and the controller 103. The server apparatus 10 is, for example, a single computer. The server apparatus 10 may be two or more computers that are communicably connected to each other and operate in cooperation. In this case, the configuration illustrated in FIG. 1 can be arranged among two or more computers as appropriate.

The communication interface 101 includes one or more interfaces for communication. The interfaces for communication include, for example, a LAN interface. The communication interface 101 receives information to be used for operations of the server apparatus 10 and transmits information obtained by the operations of the server apparatus 10. The server apparatus 10 is connected to the network 11 by the communication interface 101 and communicates information with the terminal apparatus 12 and the vehicles 13 via the network 11.

The memory 102 includes, for example, one or more semiconductor memories, one or more magnetic memories, one or more optical memories, or a combination of at least two of these types, to function as main memory, auxiliary memory, or cache memory. The semiconductor memories are, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

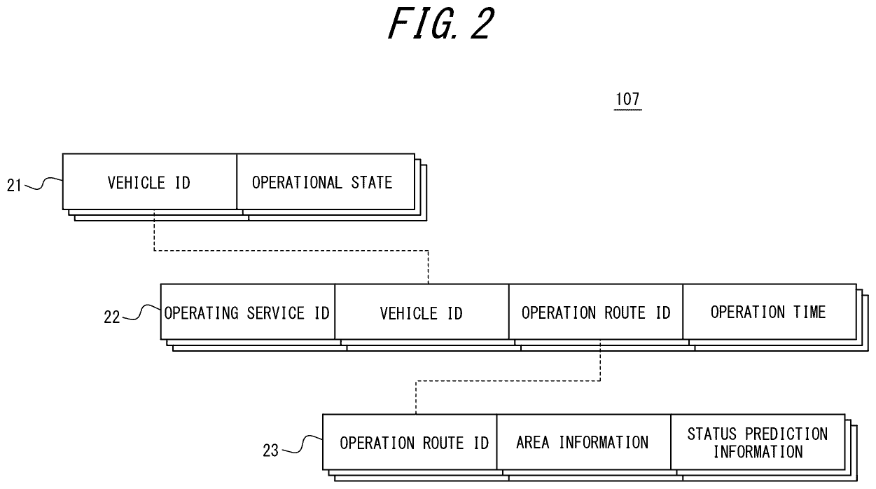

The information stored in the memory 102 includes the operation plan information 107. The operation plan information 107 includes, for example, vehicle information 21, operating service information 22, and operation route information 23, as illustrated in FIG. 2. The vehicle information 21 includes, for each vehicle 13, a vehicle ID to identify the vehicle 13 and information on the operational state indicating whether the vehicle 13 is operational or not.

The vehicle ID may include the vehicle name. The information on the operational state indicates, for example, that the vehicle 13 is operational if it does not have any defects, and that it is inoperable if the vehicle 13 has defects. The operating service information 22 includes, for each operating service assigned to each vehicle 13, an operating service ID to identify the operating service, a vehicle ID indicating the vehicle 13 to which the operating service is assigned, an operation route ID to identify the operation route on which the operating service is set, and operation times indicating when the operation will start and end. The operating service ID may include the name of the operating service. Operation times may include arrival and departure times at one or more stops on the operation route. The operation route information 23 includes, for each operation route, an operation route ID to identify the operation route, area information indicating the area in which a portion or whole of the operation route is included, and status prediction information regarding the status prediction in that area. The operation route ID may include the name of the operation route. Area information includes information for identifying an area and information indicating the attributes of the area. The status prediction information is information that indicates the prediction of the status regarding whether or not the operating service can be operated in the area. The status prediction information includes, for example, scheduled work in the area, such as road construction or accident handling, scheduled events with road closures, and predicted stormy weather affecting road traffic. Among such prediction, the prediction that causes a hindrance to operation corresponds to a non-operable reason. The vehicle information 21 and the operating service information 22, and the operating service information 22 and the operation route information 23 are linked by the vehicle ID and the operating service ID, respectively. One vehicle 13 corresponds to one operating service, but multiple routes can correspond to one area, or multiple routes to one route. Furthermore, a single route can accommodate multiple vehicles 13.

Returning to FIG. 1, the controller 103 includes one or more processors, one or more dedicated circuits, or a combination thereof. The processors are general purpose processors, such as central processing units (CPUs), or dedicated processors, such as graphics processing units (GPUs), specialized for particular processes. The dedicated circuits are, for example, field-programmable gate arrays (FPGAs), application specific integrated circuits (ASICs), or the like. The controller 103 executes information processing related to the operations of the server apparatus 10 while controlling the components of the server apparatus 10.

The functions of the server apparatus 10 are realized by execution of a control program by a processor included in the controller 103. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10, and be read from the medium by the server apparatus 10.

### <Configuration of Terminal Apparatus 12>

The terminal apparatus 12 includes a communication interface 121, a memory 122, a controller 123, an input interface 125, and an output interface 126.

The communication interface 121 includes a communication module compliant with a wired or wireless LAN standard, a module compliant with a mobile communication standard such as Long Term Evolution (LTE), 4th Generation (4G), or 5th Generation (5G), or the like. The terminal apparatus 12 connects to the network 11 via a nearby router apparatus or mobile communication base station using the communication interface 121, and communicates information with other apparatuses over the network 11.

The memory 122 includes one or more semiconductor memories, one or more magnetic memories, one or more optical memories, or a combination of at least two of these types. The semiconductor memories are, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for operations of the controller 123 and information obtained by the operations of the controller 123.

The controller 123 has one or more general purpose processors such as CPUs or micro processing units (MPUs) or one or more dedicated processors that are dedicated to specific processing. Alternatively, the controller 123 may have one or more dedicated circuits such as FPGAs or ASICs. The controller 123 is configured to perform overall control of operations of the terminal apparatus 12 by operating according to control/processing programs or operating according to operating procedures implemented in the form of circuits. The controller 123 then transmits and receives various types of information to and from the server apparatus 10 and the like via the communication interface 121, to execute operations according to the present embodiment.

The input interface 125 includes one or more interfaces for input. The interface for input includes, for example, a physical key, a capacitive key, a pointing device, a touch screen integrally provided with the display, a camera that captures images or image codes, or an IC card reader. The interface for input may include a microphone that accepts audio input. The input interface 125 accepts input of information to be used in the operations of the controller 123 and transmits the inputted information to the controller 123.

The output interface 126 includes one or more interfaces for output. The interfaces for output include, for example, a display or a speaker. The display is, for example, a liquid crystal display (LCD) or an organic electro-luminescent (EL) display. The output interface 126 outputs information obtained by the operations of the controller 123.

The functions of the controller 123 are realized by execution of a control program by a processor included in the controller 123. The control program is a program for causing the processor to function as the controller 123. Some or all of the functions of the controller 123 may be realized by a dedicated circuit included in the controller 123.

### <Configuration Example of Vehicle 13>

The vehicle 13 includes a communication interface 131, a memory 132, a controller 133, a positioner 134, an input interface 135, and an output interface 136. One or more of these may be configured as a single control apparatus, or may be configured by a personal computer including a tablet terminal, a smartphone terminal, a navigation apparatus, or the like. Alternatively, each component may be connected via an in-vehicle network compliant with a standard such as controller area network (CAN) to enable communication of information.

The memory 132, the controller 133, the input interface 135 and the output interface 136 have configurations equivalent to those of the memory 122, the controller 123, the input interface 125 and the output interface 126 of the terminal apparatus 12, respectively.

The communication interface 131 includes one or more interfaces for communication. Examples of the interface for communication include an interface corresponding to mobile communication standards, such as LTE, 4G, or 5G. The communication interface 131 receives information to be used for operations of the controller 133, and transmits information obtained by the operations of the controller 133. The controller 133 connects to the network 11 using the communication interface 131 through a mobile communication base station, and communicates information with other apparatuses via the network 11.

The positioner 134 includes one or more Global Navigation Satellite System (GNSS) receivers. The GNSS includes, for example, Global Positioning System (GPS), Quasi-Zenith Satellite System (QZSS), BeiDou, Global Navigation Satellite System (GLONASS), and/or Galileo. Based on information acquired by the positioner 134, positional information for the vehicle 13 is obtained.

The controller 133 controls each of the communication interface 131, the memory 132, the positioner 134, the input interface 135, and the output interface 136 while exchanging various information with these components and also controls the operation of the vehicle 13. At the time of operating the vehicle 13, the controller 133 controls the operation of the vehicle 13 by presenting various information necessary for the operation to the driver via the output interface 136 and/or by controlling the automatic operation of the vehicle 13.

### <Operations of Operation Management System 1>

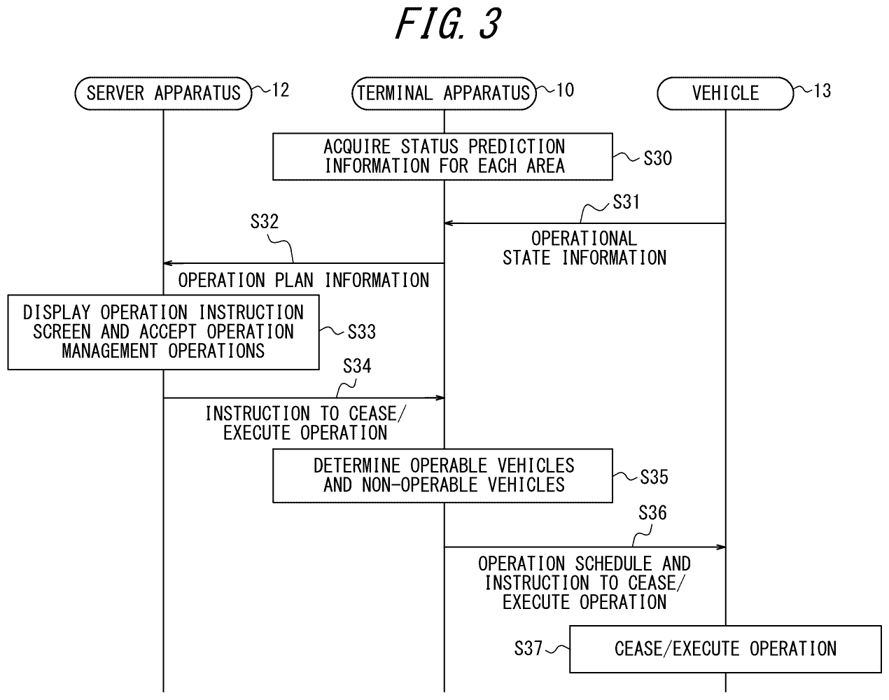

FIG. 3 is a sequence diagram illustrating an example procedure for coordinated operations of the server apparatus 10, the terminal apparatus 12, and the vehicles 13. The steps pertaining to various types of information processing by the server apparatus 10, the terminal apparatus 12, and the vehicles 13 in FIG. 3 are performed by the respective controllers 103, 123, and 133. The steps pertaining to transmission and reception of various types of information to and from the server apparatus 10, the terminal apparatus 12, and the vehicles 13 are performed by the respective controllers 103, 123, and 133 transmitting and receiving information to and from each other via the respective communication interfaces 101, 121, and 131. In the server apparatus 10, the terminal apparatus 12, and the vehicles 13, the respective controllers 103, 123, and 133 appropriately store the information that is processed, transmitted and received in the respective memories 102, 122, and 132. Furthermore, in the terminal apparatus 12 and the vehicle 13, information input by user operation is accepted by the input interfaces 125 and 135, respectively, and various information directed to the user is output by the output interfaces 126 and 136, respectively.

The FIG. 3 procedure is an example of a procedure to be performed when an operation manager uses the terminal apparatus 12 to manage the operation of vehicle 13 via the server apparatus 10. For example, the operation manager performs the operation management operation once before the start of each operating day.

In step S30, the server apparatus 10 acquires status prediction information for each area. When the operation manager instructs the server apparatus 10 to acquire the status prediction information using the terminal apparatus 12, the server apparatus 10 acquires the status prediction information. The server apparatus 10, for example, acquires information including scheduled work such as road construction or accident handling, scheduled events with road closures, and predicted stormy weather, from the servers of operators that distribute road traffic information, event information, weather information, etc., and updates the status prediction information in the operation route information 23 using the acquired information.

In step S31, the server apparatus 10 acquires operational state information for each vehicle 13. When the server apparatus 10 transmits a request for operational state information for each vehicle 13 using the vehicle ID of each vehicle 13, each vehicle 13 transmits operational state information to the server apparatus 10 in response to the request. In each vehicle 13, for example, maintenance and inspection workers of the vehicle 13 input information on the operational state of the vehicle 13, including whether the vehicle 13 has any defects, and the input information is sent to the server apparatus 10. The server apparatus 10 updates the information on the operational state of the vehicle information 21 with the information sent from each of the vehicles 13. The server apparatus 10 may, for example, change an inoperable vehicle 13 to an operable vehicle 13 based on the information on the operational state if the operating service information 22 is assigned to the inoperable vehicle 13 in the operation plan information 107.

In step S32, the server apparatus 10 transmits information on operation plans to the terminal apparatus 12. The operation plan information sent from the server apparatus 10 includes at least some of the operation plan information 107. For example, the information in the operation plan includes updated information on the operational state of each of the vehicles 13 and the status prediction information for each area.

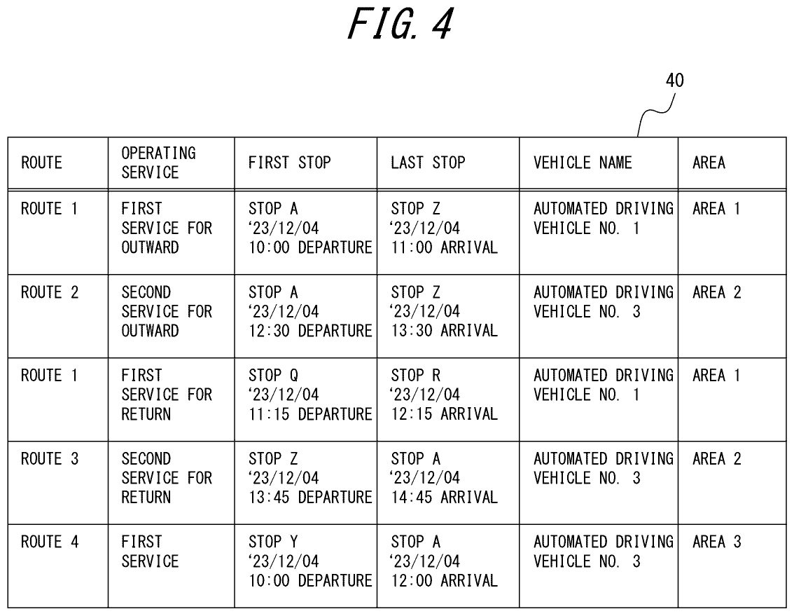

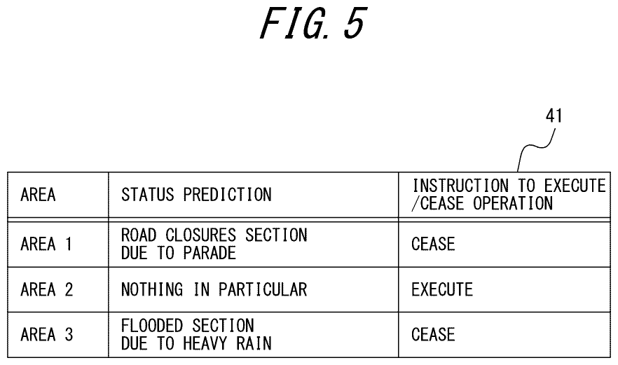

In step S33, the terminal apparatus 12 displays the operation instruction screen and accepts operation management operations from the operation manager. Based on the operation plan information received from the server apparatus 10, the terminal apparatus 12 displays, for example, an operation schedule 40 as illustrated in FIG. 4 and status prediction 41 for areas as illustrated in FIG. 5 as an operation instruction screen. The operation schedule 40 includes information on items such as the name of the operation route, the name of the operating service, the departure time at the first stop, the arrival time at the last stop, the name of the vehicle, and the name of the area in which part of the route is included. The status prediction 41 for an area includes the name of the area and information indicating the status prediction. By checking the operation instruction screen, the operation manager can recognize, for example, that there are non-operable reasons, such as road closures in “Area 1” or flooded section due to heavy rain in “Area 3”, and can determine that “Area 1” and “Area 3” are non-operable areas. On the other hand, the operation manager can recognize that in “Area 2”, a non-operable reason is not expected, and therefore, operation is possible. The operation manager, for example, enters an instruction to “execute” or “cease” the operation corresponding to each area in the “Instruction to Execute/Cease Operation” field in the status prediction 41. For example, the operation manager can enter instructions to execute or cease an operation by selecting or directly entering one of the “Execute” or “Cease” options that are displayed. In this case, to “Cease” the operation is instructed for “Area 1” and “Area 3”, which are non-operable areas, and to “Execute” the operation for “Area 2”.

Returning to FIG. 3, in step S34, the terminal apparatus 12 transmits an instruction to cease/execute operation set for each area to the server apparatus 10.

In step S35, the server apparatus 10 determines vehicles 13 that are non-operable and vehicles 13 that are operable. Using the operation plan information 107, the server apparatus 10 determines the vehicles 13 associated with operating services on a route a portion of which is included in the area for which cease of operation has been instructed as non-operable vehicles and the vehicles 13 associated with operating services on a route a portion of which is included in the area for which execution of operation has been instructed as operable.

In step S36, the server apparatus 10 transmits the operation schedule based on the operating service information 22 to each of the vehicles 13, as well as the instructions to cease operating to the vehicles 13 that are determined to be non-operable vehicles and the instructions to execute operation to the vehicles 13 that are determined to be operable, respectively.

In step S37, each vehicle 13 ceases or executes the operation according to the operation schedule sent from the server apparatus 10 and the instructions to cease/execute the operation. The vehicles 13 determined to be non-operable vehicles will cease operation, while the vehicles 13 determined to be operable will execute the operation based on the operation schedule. In each vehicle 13, the controller 133 controls the vehicle 13 for operation execution or discontinues such control based on information sent from the server apparatus 10. Alternatively, the controller 133 may output the operation schedule and instructions to cease/execute the operation by display or other devices, and the crew may perform operations to execute the operation or suspend such operations. The same information as the operating service information 22 in the operation plan information 107 stored in the server apparatus 10 is stored in advance in each vehicle 13, and each vehicle 13 may execute the operation based on that information.

According to the procedure described above, the operation manager can instruct the vehicles 13 scheduled to operate in a non-operable area to cease operating on a non-operable area basis. Furthermore, when multiple vehicles 13 are scheduled to operate on each route in a non-operable area, it is possible to instruct multiple vehicles 13 to cease operating. Therefore, when multiple vehicles 13 are scheduled to operate on one or more routes in a non-operable area, the operation manager does not need to instruct each vehicle 13 to cease operating. Even when multiple vehicles 13 of different standards and specifications operate in a non-operable area, the communicably configuration of the server apparatus 10 and each of the vehicles 13 makes it possible to instruct them to cease operating all together. Thus, it is possible to improve operational efficiency for operation management.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each element, each step, or the like can be rearranged without logical inconsistency, and a plurality of elements, steps, or the like can be combined into one or divided.

1. An information processing apparatus comprising:
a communication interface;
a memory configured to store information on an operation plan for each of a plurality of vehicles, the operation plan including an operation route a portion or whole of which is included in one or more areas; and
a controller configured to:
communicate using the communication interface;
transmit, to a terminal apparatus, information indicating operation plans for the plurality of vehicles and a first area for which a predetermined reason has occurred; and
upon receiving, from the terminal apparatus, an instruction to cease operating in the first area, transmit an instruction to cease operating to a first vehicle a portion or whole of an operation route for which is included in the first area.

2. The information processing apparatus according to claim 1,
wherein the controller is configured to transmit an instruction to execute operating to a second vehicle a portion or whole of an operation route for which is not included in the first area.

3. The information processing apparatus according to claim 2, wherein the controller is configured to transmit the instruction to cease operating and an instruction to start operating to the first and second vehicles, respectively, before respective operation start times included in operation plans for the first and second vehicles.

4. The information processing apparatus according to claim 1, wherein the controller is configured to transmit the instruction to cease operating to multiple vehicles corresponding to a single operation route.

5. An operating method of an information processing apparatus configured to store information on an operation plan for each of a plurality of vehicles, the operation plan including an operation route a portion or whole of which is included in one or more areas, the operating method comprising transmitting, to a terminal apparatus, information indicating operation plans for the plurality of vehicles and a first area for which a predetermined reason has occurred, and upon receiving, from the terminal apparatus, an instruction to cease operating in the first area, transmitting an instruction to cease operating to a first vehicle a portion or whole of an operation route for which is included in the first area.
